(19) United States
(12) Patent Application Publication
(10) Pub. No.: US 2017/0239126 A1
(43) Pub. Date: Aug. 24, 2017

(54) Self-Actuated Device for Lumbar Traction and Flexure

(71) Applicants: Thierry Deegan, Portsmouth, RI (US); Nicole Dieso, Portsmouth, RI (US)

(72) Inventors: Thierry Deegan, Portsmouth, RI (US); Nicole Dieso, Portsmouth, RI (US)

(21) Appl. No.: 15/052,262

(22) Filed: Feb. 24, 2016

(51) Int. Cl. A61H 1/02

(52) U.S. Cl. CPC A61H 1/0292; A61H 1/02; A61H 2001/0207; A61H 2201/0134; A61H 2201/1253; A61H 2203/0443; A61H 2201/1642

(57) ABSTRACT

This invention is an apparatus and an associated method with which a person may self-apply concurrent spinal traction and lateral spinal flexure. The apparatus comprises a mobile carriage with ankle grips, long handles and flexible links to a floor pad that is held in place by the weight of the user's upper torso. The user applies arm pressure to the handles so as to urge the carriage and the user's ankles away from the user's torso. This force on the user's ankles applies a stretching force (traction) to the user's lower spine. Alternating a slightly greater force on the handles causes the carriage, constrained by links to the floor pad, to swing to and fro in a lateral arc. The concurrent application of user-induced traction and lateral spinal flexure is but one advantage of the apparatus and is a novel combination in the field of exercise and therapeutic devices.

### CROSS REFERENCE TO RELATED APPLICATION

Not applicable

### FEDERALLY SPONSORED RESEARCH

Not applicable

### TECHNICAL FIELD

The present invention relates to therapeutic and exercise equipment, and more particularly to equipment for the treatment and relief of maladies of the lower spine.

Many spinal maladies present a stiffness of motion due to the nesting of vertebral prominences that causes a resistance to flexure. Spinal traction is a commonly applied therapeutic technique intended to relieve this stiffness. Traction stretches the ligaments, muscles, and connective tissues surrounding the spine to promote separation of the vertebrae. Separation of the vertebrae by traction is intended to improve the range of motion. Exercises that flex the spine are often prescribed between traction treatments to enhance the flexibility promoted by traction.

It is known of many lumbar traction treatment techniques that an immediate treatment response to the user's subjective physical feelings yields an effective and efficient result in the treatment. Conversely, a delay between sensation by the user and adjustment of the treatment can cause the user to resist the treatment as it is proceeding or even to forego the treatment altogether so as to avoid the incipient pain.

### PRIOR ART

There are many devices for treatment of spinal maladies in prior art and the application of traction is a feature of the many of them. How traction is applied varies considerably among these devices. For example, van Zuilichem's U.S. Pat. No. 4,930,524, consist of a table with longitudinal tracks. The user's upper torso is restrained on a fixed portion of the table and the user's pelvis is bound to a moving portion. The moving portion is pulled by the machine under the control of an external operator to apply traction to the user's spine. Such a device is quite large, not generally portable, and requires an attendant to apply bonds and to control the traction force. Traction is applied in a single dimension: axially, in line with the spine. The subject on the table does not have control of the amount of traction applied and must communicate reactions to the degree of stretching to the operator, who then may adjust the force.

Saunders's U.S. Pat. No. 7,108,671 has a sled, a thoracic girdle, and a pelvic girdle similar to those in Zuilichem's apparatus, but traction is applied by the user through a lever actuated by the user's legs.

Self-actuating traction devices, such as Leier's U.S. Patent Application 2013 0079205, employ the user's body weight as a source of traction force by inclining the body on a table that pivots on a horizontal axis. With the user's ankles bound to the table, the table is inclined in a head-downward angle. The weight of the user's upper body applies a traction force to the spine. The user has control of the angle of depression reached by the table with an adjustment that shifts the user's center of mass with respect to the pivot axis of the table, as well as a pre-positioned tilt-stop block. Getting a suitable adjustment of this body position requires experience or training with the apparatus; an unpracticed user may inadvertently be positioned inappropriately and induce an excessive tilt and an undesirably large and potentially painful traction force. In addition, the head-down position of this apparatus is disquieting to many users and the gravity-induced increase of blood pressure in the brain is inappropriate for users with hypertension. Also, this device applies more traction force to the user's knees and ankles than to the spine, due to the mass of the user's legs. This excess traction in the extremities may be unsuitable for some users.

Other self-actuating devices, such as Eberling's U.S. Pat. No. 4,524,763, suspend the user's upper body on a ramp and use the weight of the user's lower body to apply a traction force to the spine. The inclination of the ramp and effort in the user's legs control the amount of traction applied. The weight of the hips, being less than that of the torso implies that the traction applied by this device is less than that of Leier's head-down device. In Eberling's apparatus, the lumbar spine receives traction force only from the weight of the user's pelvis and legs. Also in Eberling's apparatus, the thoracic spine receives greater traction than the lumbar spine from the weight of the user's torso, in addition to the weight of the user's legs. This is undesirable if the focus of the therapy is the lumbar spine. The harness around the user's rib structure and its attachment to the ramp may raise fears of confinement in some users. Such aversion may be common to other devices with similar restraints.

Anthony's U.S. Pat. No. 5,031,898 has the user bend over a torso-support table that includes a sled that carries the user's upper torso. The user pulls on ropes that run over pulleys such that the sled is drawn away from the user's hips, thus applying traction to the spine.

McGuire's U.S. Pat. No. 6,113,564 has a pelvic girdle attached to a block and tackle anchored at the top of a convenient door. The user pulls a downfall to hoist the pelvis and apply traction to the spine. Though not apparently an intended consequence, this apparatus also imposes an anterior curvature of the spine, as the user's pelvis is lifted from a horizontal to a vertical position by the hoist.

Starr's U.S. Pat. No. 6,994,683 has a pelvic girdle pulled by a user-controlled ratchet and spring that are anchored in a convenient door frame. Friction between the user's upper body and the floor provide the counterforce for the traction in the spine.

Herbst's U.S. Pat. No. 6,634,999 bends the user's spine over a bowed surface to have the user's upper body on one side of the bow and the lower body on the other side of the bow. This applies a posterior curvature to the portion of the spine over the bow. The bowed surface applies a bend in the spine that stretches the tissues anterior to the spine and compresses tissues on the posterior surface. Similarly, the yoga wheel or a large exercise ball can be used to perform the same function. Controlling the force applied to the spine is possible if the legs are kept bent and the feet flat on the floor so as to adjust the elevation of the pelvis with respect to that of the bowed support. The weight of the head and shoulders cannot be adjusted, however, and once they are cantilevered beyond the bow so as to place the bend low in the spine, they may impose an undesirably large force in the spine. These devices apply no traction to the spine, only bending.

Graham's U.S. Pat. No. 5,713,841 bends selected segments of the user's spine with pneumatic bladders placed between the user and a floor pad. The user or an attendant controls the degree of anterior bow of the spine by adjusting fluid pressure in the bladder. Increased pressure inflates the bladder and lifts the local segment of the lower spine while the weight of the user's body above (toward the user's head) and below (toward the user's pelvis) the bladder apply counterforce. For use on the cervical spine, the device includes a restraint strap to hold the user's head against the floor pad while the bladder lifts the user's neck.

Dunfee's U.S. Pat. No. 5,724,993 uses linear-extension pneumatic bladders to apply spinal traction between a rib-girdle and a pelvic girdle. The user or an attendant applies traction to the spine by inflating the bladders, which causes them to lengthen and apply a spreading force between the ribs and the pelvis.

None of the above devices provide lateral flexure to the spine. Although, Abdo's U.S. Pat. No. 6,022,303 is an exercise device upon which the user sits and rotates the torso to exercise abdominal muscles and to rotate the spine on its axis about a fixed-position pelvis. His U.S. Pat. No. 6,248,047 includes a torsion spring for muscle resistance training.

Lateral leg movement with mild traction is the motion that massage therapists often use to relax pressure in the spine. The therapist lifts the subject's feet and pulls on the lying subject's ankles while swinging the legs in an alternating sideways motion. The pulling opens the spinal joints and the swinging stretches spinal ligaments and muscles.

None of the prior-art items apply both self-actuated traction and lateral spinal flexure. None provide direct, positive, and precise real-time control of the traction and flexure forces by the user.

### SUMMARY OF THE EMBODIMENTS

The present invention is a therapeutic apparatus and an associated method for self-treatment of disorders and discomfort of the lumbar spine. The apparatus provides means to deliver force from the user's arms to impose two types of force to his or her legs: a traction force and an alternating lateral-displacement force. The traction force on the user's legs pulls on the user's pelvis, which applies traction to the user's spine. The lateral-displacement force on the user's legs rotates the user's pelvis, which flexes the user's spine. With this device, the user applies both traction and lateral flexion to the spine to improve vertebral positioning and to increase the flexibility of ligaments and muscles in the lumbar region. The user controls directly the amount of traction with arm force applied to the handles of the apparatus. Similarly, the user induces the desired degree of lateral spinal flexure with slightly asymmetrical arm force on the two handles. Stronger force on one side pushes a carriage that holds the user's ankles toward the opposite side. When the displacement of the carriage causes the desired spinal flexion, the user reverses the arm force to swing his or her legs back and straighten the spine. By alternating the lateral-displacement force, the user swings his or her legs to and fro while maintaining mild traction. Such direct control by the user of the strain imposed on the spine minimizes the potential personal discomfort encountered during treatment of lower-back pain. The apparatus is portable and easily set up, allowing the user to employ the device as the need requires, to store it between uses, and to transport it in connection with travel.

Unique to the present invention is the concurrent application of traction and lateral flexure; concurrency of these actions enhances the therapeutic effect. Traction reduces the force pressing spinal elements together and flexure is imposed to stretch the ligaments and other tissues surrounding the vertebrae so as to increase freedom of movement. It is the concurrent lateral leg movement combined with traction through the user's legs that the present invention applies. The present invention does so with no external attendant and the intervening need for the user to describe the sensation or degree of pain to the attendant to forestall over-extension.

One or more embodiments of the present invention include

means to hold the user's ankles for force application,

means to deliver arm force to the ankles,

means to elevate the user's ankles,

means to control the kinematics of the motion of the user's legs,

means to adjust the kinematics for users of various heights,

means to hold the apparatus under the lying user, and

means to elevate the user's torso.

The objects and advantages of the present invention are made apparent in the course of the following description of several embodiments of the invention.

### BRIEF DESCRIPTION OF DRAWINGS

FIG. 1 is an isometric view of the first embodiment of the invention.

FIG. 2 is a plan view of the carriage, illustrating the ankle restraint

FIG. 3A is a plan view of the first embodiment of the apparatus, with the user's legs in a neutral, that is, centered position.

FIG. 3B is a plan view of the first embodiment of the apparatus, with the user's legs displaced.

FIG. 3C is a plan view of the first embodiment of the apparatus, with the user employing a narrow-spread arm configuration and shortened handles.

FIG. 4 is a plan view of the second embodiment.

The following are numbered items in the drawings:
5 carriage
6 ankle grip (two)
7 handle (two)
8 radial link (two)
9 floor pad
10 wheel
11 wheel stem
12 handle anchor joint
13 hand grip
14 collet (for adjustment of handle length)
15 link pivot
16 link stop
17 link anchor slot
18 torso support pillow
21 thickness (of the user's lower shin)
22 leg (of the user)
23 dimension (width of ankle prominences)
25 padding (of ankle grip)
26 pneumatic bladder (alternative padding)
31 wide arm spread
32 narrow arm spread
33 equal force
34 additional force
35 displacement (of the carriage)
36 arc (of the motion of the carriage)
37 curve (of the user's spine)
41 T-handle

### DETAILED DESCRIPTION AND OPERATION

### Advantages

The present invention, unlike prior art, applies spinal traction concurrently with lateral spinal flexure. It does so without an attendant and the intervening need for the user to describe the sensation or degree of pain to the attendant to forestall over-extension. The user is not strapped into or confined by the apparatus. The user lies on the apparatus and grips the handles. The user's ankles are nestled in contoured slots and may be lifted out at any time; there are no bonds to be released. Neither does the apparatus require the operator to subject his or her body to any position other than a simple supine posture on the floor.

### Detailed Description of the First Embodiment

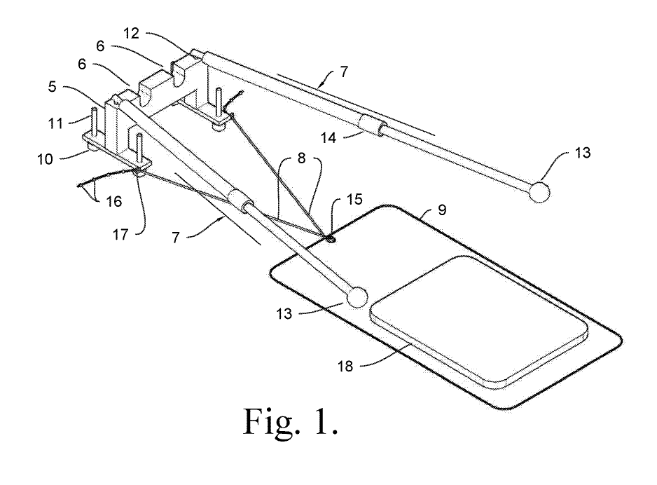

Directing attention to FIG. 1, the present invention is shown to comprise a carriage 5, which incorporates two slots 6 that constitute grips for the user's ankles, two handles 7 that reach from the carriage to the location of a lying user's hands, and two flexible and adjustable radial-link members 8 that constrain the motion of the carriage with respect to a floor pad 9. The apparatus is substantially symmetrical about the vertical plane through the long dimension of floor pad 9.

Carriage 5 has a plurality of wheels 10, casters, ball rollers, skids, or other friction-reducing elements familiar to those skilled in the art to allow carriage 5 to move easily on a flat operating surface, such as a floor. The height of carriage 5 is such that ankle grips 6 elevate the user's claves and lower thighs above the floor, making them free to traverse laterally without substantial friction from floor. Wheels 10 may be mounted on carriage 5 in a fixed position or connected to the carriage by way of an elongated stem 11, other extensible member, or articulated geometry familiar to those in the art. The extensible wheel attachment allows the height of carriage 5 to be adjusted for the comfort of the user and to accommodate the thigh dimension of a wide range of users.

Carriage 5 may be made of any material that provides sufficient strength and stiffness for the application. Lightness is a primary consideration for low inertia, making any number of plastics suitable. Stamped thin metal may offer potentially low cost. These choices have little influence on the function or operation of the apparatus and may be made for economic or cosmetic reasons or for ease of manufacture and maintenance.

Handles 7 are connected to carriage 5 in the horizontal plane shared by the axes of the user's legs held in ankle grips 6 so that the thrust of handles 7 is delivered to the user's ankles without imposing a vertical torque to carriage 5. The handle anchor joints 12 between handles 7 and carriage 5 deliver thrust from the user's hands to carriage 5, while allowing handles 7 to pivot as carriage 5 moves laterally. These joints include vertical play, which allows the user to employ a range of arm motions for a comfortable action of the apparatus. The embodiment illustrated employs a ball-and-socket mechanism for this connection. This connection may include a spring-loaded collar or other rapid-action closure that allows the handle to be detached quickly from the carriage for storage or transport.

Handles 7 are long enough for the user to apply arm thrust to carriage 5 when the operator is lying on floor pad 9 with his or her ankles in ankle grips 6 of carriage 5. Handles 7 can be of adjustable length to accommodate users of differing heights. Tall users need longer handles than do short users so as to have hand grips 13 at a position suitable for delivering desired forces to carriage 5. Adjustable handles also allow hand grips 13 to be placed at positions that cause different muscle groups to be used to apply thrust and moment to carriage 5. One method of controlling this length adjustment uses nested (telescoping) tubes with collet 14 at the joint of the tubes to set the length. Other methods known commonly to those in the art, such as detent pins that are spring-loaded or through-pins that are manually inserted through aligned holes in the two tubes, can be used alternatively.

The spherical shape of hand grip 13 plays a role in the utility of the variable length of the handles. Grips of other shapes, such as those on bicycle handles and ski poles, may offer a theoretically stronger grip, but they tend to impose a fixed hand orientation, which limits the variability of arm positions available to the user. Such fixed-orientation handles are, therefore, less fruitful in delivering suitable thrust to carriage 5 by users with some types of physical incapacity.

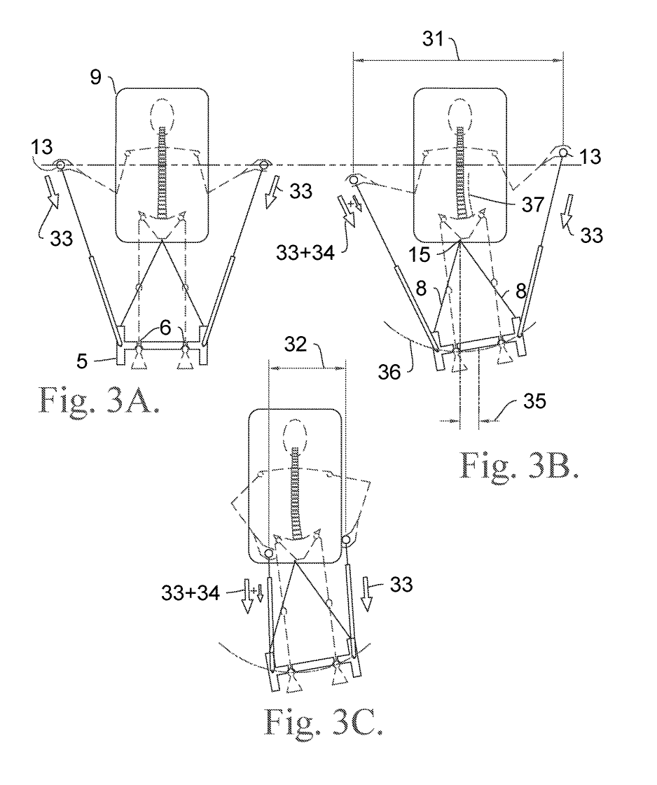

The distance from carriage 5 to floor pad 9 is controlled by two radial links 8. These links are strings, ropes, straps, chains, or other flexible linear members that allow carriage 5 to swing in a lateral arc 36 (see FIG. 3B) that is anchored by floor pad 6 and centered on link pivot 15. Radial links 8 include a plurality of stops 16, buttons, or other discrete fasteners or strips of hook-and-loop fastener material, which allow the active length of radial links 8 to be adjusted by the user prior to use of the apparatus. If radial links 8 are ropes with stops, then they can be fastened to carriage 5 in contoured anchor slots 17 that allow the rope portion, as a neck, to slip into a slot that also has a widened seat for the broad link stop 16. Similarly, if the radial link members are implemented as chains, then a link can be inserted into a slot that has contours for the shoulders of the first link of the flying end of the chain. Such contoured slots are common in the field of rigging and handling equipment. Hooks for chains, loops for straps with buttons, or other discrete fasteners can be used alternatively, but the contoured slot for link anchor slot 17 is analogous to the shape of ankle grip 6. The similarity of appearance and functional action of the contoured slot concept applied to both ankle grip 6 and link anchor slot 17 enhance the operability of the apparatus.

Floor pad 9 is long enough to accommodate the distance from the buttocks to the head of tall users. It is wide enough to accommodate the hip swing of a large user during use of the apparatus. Link pivot 15 for the radial links 8 is at the tail end of floor pad 9. Floor pad 9 and floor pads of alternative geometry are made of thin material that may be rolled up for storage or in panels that are joined by flexible hinge sections, which allow the pad to be folded for storage. Floor pad 9 is made of a material with a smooth finish that minimizes the friction under the user's buttocks, so as to allow the hips to slide laterally as the legs are translated left and right.

Ease of lateral movement of the pelvis during use of the apparatus may be enhanced by forming a raised section of floor pad 9 or by making this raised section an independent torso support pillow 18 that is placed under the user's ribs on floor pad 9. Pillow 18 elevates the user's back and hips slightly so as to reduce the friction of floor pad 9 on the user's buttocks. Keeping pillow 18 in position on floor pad 9, when in use, while allowing convenient re-positioning for different users, can be implemented with patches of hook-and-loop fasteners on the underside of the pillow and the top surface of the floor pad (not illustrated).

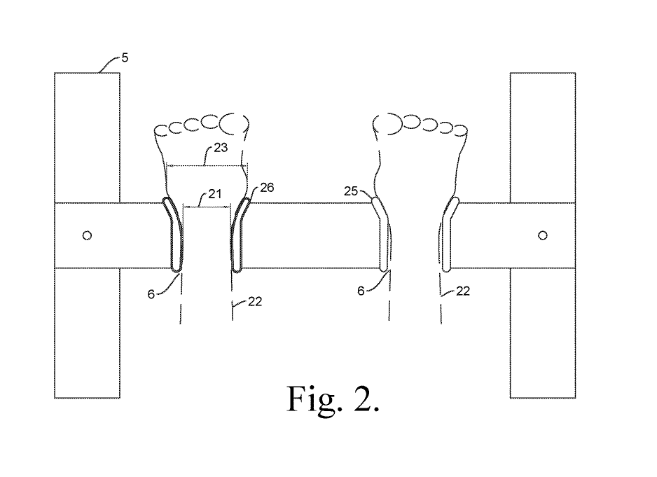

As shown in FIG. 2, each ankle grip 6 is a concavity whose width accommodates the thickness 21 of the user's lower leg 22, but is narrower than the dimension 23 from the medial malleolus to the lateral malleolus of the user's ankle. Thus, with a leg placed in each narrow slot, the condyles of the tibia and fibula together act as a stop which prevents the passage of ankle grip 6 toward the foot. The effect of this stop is to take forces that are directed by handles 7 substantially parallel to the user's legs through carriage 5 in the direction toward the user's feet and couple them to the user's ankles. This force from handles 7 into carriage 5, passing through ankle grips 6, is thusly delivered as a tension along the user's legs to pull on the user's pelvis, which, in turn pulls on the section of the user's spine that is between the user's pelvis and the user's thorax, which is resting on floor pad 9. The section of the spine to which this traction is applied is the lumbar spine.

The surface of ankle grip 6 is covered with a soft material 25 such as urethane foam to prevent abrasion of the skin. The padding is contoured to offer a three-dimensional nest or socket for the prominences of the ankles. Such contouring provides not only even tension to the leg bones but also a small degree of vertical restraint of the ankles. This vertical restraint is effective in allowing the user to sit up to make minor adjustments to the apparatus, without having to extract the ankles from ankle grips 6. Removable padding of differing thickness may be used in ankle grip 6 to accommodate the variability of the widths of the ankles of the potential user population. Alternatively, the padding of ankle grip 6 may contain pneumatic bladders 26 that the user fills to both adjust the size of grip 6 and to pad the ankles.

An alternative ankle grip, consisting of straps with buckles or bands with hook-and-loop fasteners, may be used in lieu of the foam-lined ankle socket, but some users find unsettling the feelings instilled by being bound by their extremities. The socket-like ankle grip of the illustrated embodiment avoids this problem.

### Operation of the First Embodiment

Before use, the lengths of radial-links 8 are adjusted by inserting a link stop 16 into each link anchor slot 17 on carriage 5, such that the distance from floor pad 9 to carriage 5 is slightly less than the length of the user's legs. This positions link pivot 15 under the user's hips, as shown in FIG. 3A. The lengths of the two radial links 8 are chosen to be equal on the two sides, so as to make symmetrical the traction force applied to the carriage and the resulting motion of the user's legs.

The lengths of handles 7 are adjusted by the user to place hand grips 13 at a location suitable for delivery of thrust to carriage 5 by the lying user. FIG. 3B shows the use of a wide arm spread 31, with long handles. In this geometry, the user employs the latissimus and pectoral muscles, while a narrower spread 32 of FIG. 3C, using short handles, relies more on the triceps of the arm and subscapularis of the shoulder. Irrespective of the musculature, the principle objective of the adjustable handles is to allow the user to select a handle action that is most comfortable for him or her in applying the thrust and moment forces for spinal traction and lateral flexure.

To use the apparatus, the user lies on floor pad 9, as illustrated in FIG. 3A, with his or her coccyx near or on top of link pivot 15, where radial links 8 are connected to floor pad 9, and places his or her ankles in ankle grips 6 on carriage 5. The user then grips handles 7 at hand grips 13 and applies force toward carriage 5 with two objectives. First, an equal force 33 is applied to both handles 7 so as to urge the carriage away from the user's torso, in the direction of the user's feet. This force is transferred from the carriage to the user's legs, through the pelvis and results in the application of a traction force in the lower spine. Second, as illustrated in FIG. 3B, an additional force 34 toward carriage 5 is applied to one handle. Alternatively, the user may displace one handle outwardly to create a greater moment of the force on one side of the carriage. The imbalanced forces on the two sides of carriage 5 induce a displacement 35 of carriage 5 from the axis of the user's upper body. Being constrained by radial links 8 to floor pad 9, carriage 5 moves along arc 36 away from the side with the greater applied force. The movement of carriage 5 carries the user's ankles in arc 36 and pulls the legs to one side so as to translate the user's pelvis slightly to one side and to rotate the user's pelvis in the horizontal plane. The translated and rotated pelvis flexes the user's lumbar spine in lateral curve 37. When the user feels that motion in one direction is sufficient, then he or she lessens the force on the over-driven handle to the level of the desired traction and increases the force on the other handle to have the carriage travel in the opposite direction. The extra force above the desired traction force is applied alternately with one arm and then the other so as to have the user's legs swing to and fro for alternating spinal flexure, all the while that traction is applied. This flexing motion with spinal traction is the desired therapeutic action of the present invention. Spinal flexure concurrent with traction is a novel feature of the present invention over prior art.

The motion of the carriage is not a simple arc. If it were, then the two flexible radial links 8 could be supplanted by a single rigid link joining the carriage and the floor pad 9. Rather, carriage 5 must be allowed to travel over a slender figure-8 path if undesirable bending is to be avoided in the user's ankles and lower legs. Radial links 8 are flexible so as to allow this action. Rigid links with end fasteners that are free to move in slots aligned with the length of the members would yield the same kinematics.

### Description of the Second Embodiment

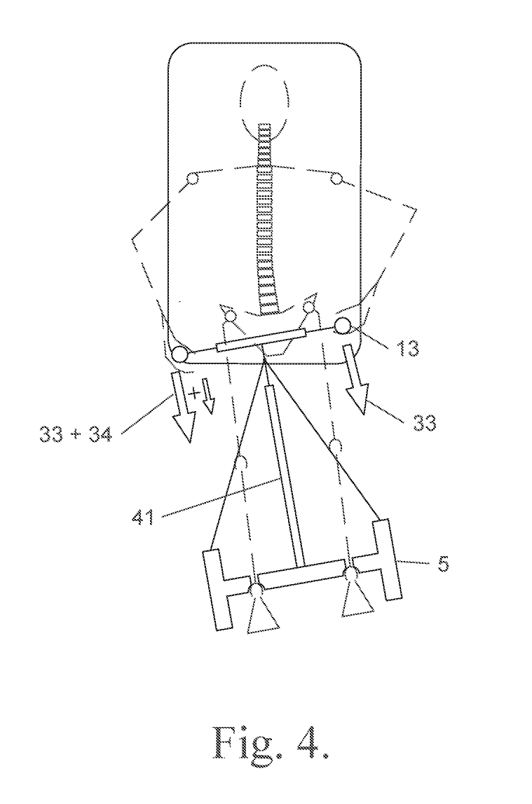

A single T-shaped handle 41 can be used to direct forces from the user's hands to carriage 5, as illustrated in FIG. 4. The T-handle attaches to the center of carriage 5 through a joint that can deliver a moment in the horizontal plane to carriage 5, while maintaining the ability to pivot in the vertical plane. Hand grips 13 on the ends of the top of the T deliver the balanced traction force 33 and the imbalanced flexure force 34 to carriage 5. The shaft of the T and the arms of the T can have telescoping elements and stops as described for handles 7 to enhance the range of arm motions and hand positions. As the user's legs at carriage 5 and the anchor point of the handle all must be co-planar, the shaft of T-handle 41 has a vertical jog (not illustrated in the plan view of FIG. 4), similar to that of some snow shovels, to allow the upper portion of T-handle 41 to clear the user's thighs.

### Ramifications, Variants, and Scope

The embodiments of the present invention described above illustrate a small range of the possible configurations that deliver the required forces to users of various dimensions. There are alternative implementations for several aspects. They are described but not illustrated, as such alternatives are readily available to those skilled in the art.

Alternative implementations exist particularly to obviate the resistance of thick carpeting to the anti-friction capability of carriage wheels of modest size and inertia. For example, floor pad 9 can be long enough to extend from the top of the lying user's head to just beyond the arc 36 for the tallest user. This configuration has the carriage rolling on the extended floor pad and the pivot 15 for the kinematic restraint links 8 is near the middle of the extended floor pad. A further alternative retains the short floor pad 9 under the user's body and adds a second pad, exclusively for the roller path of arc 36, under carriage 5. This separate roller-path pad under carriage 5 is kept in place during operation of the apparatus by temporary attachments to floor pad 9 through links that are substantially rigid in the plane of floor pad 9.

Means by which the height of carriage 5 off the floor is established can be embodied in a suspension sling that connects the two lateral ends of carriage 5 to a convenient high point, such as the frame of an open doorway. The bottom of the sling carries both ends of carriage 5 so as to keep carriage 5 substantially horizontal. A portable clamp, as commonly used in home exercise equipment, fastens the top end of the suspension sling to the middle of the door frame. Alternatively, clamps of the type used for temporary closet storage fixtures can be used to attach the carriage suspension sling either to the top of a hinged door, to the open edge of such a door or even to the door-lock handles or knobs of an open door. The sling can be adjustable in length to vary the elevation of the user's ankles by the means described for radial links 8. If the apparatus is used with an open door that is free to swing, then, before use, the user aligns the axis of floor pad 9 with the plane of the partially open door. During operation of the apparatus, the arc of the door that follows the user's feet as they swing to and fro is opposite that of arc 36 of the motion of carriage 5, but this is of no consequence, as long as carriage 5 is substantially free to move along arc 36 and is not constrained to follow the arc of the door. Such freedom is provided by a flexible and substantially vertical suspension sling that allows carriage 5 to move freely in a horizontal plane.

Restraint of pillow 18 on floor pad 9 of the first embodiment can alternatively be accomplished with strings extending from pillow 18 to be tied to through-holes located along the side edges of floor pad 9. Similarly, ribbons with snap fasteners can be mated with snap anchors on floor pad 9. Many other fastening solutions available to those in the art may be applied to this function.

Friction that inhibits the motion of the user's hips can be reduced by adding a moveable seat to floor pad 9. This seat can comprise a contoured upper surface to cradle the user's buttocks over a plurality of small ball bearings. The balls allow the seat to translate and rotate easily over floor pad 9 as the user's pelvis moves in response to traction and translation forces applied to carriage 5. Alternatively, the friction-reducing element can be a volume of lubricant in a flexible casing that is wide enough to accommodate the width of the user's hips, plus the full lateral range of the hip swing of a tall user. A further alternative provides two stages of motion accommodation, with a lateral track incorporated into the lower end of floor pad 6 and a rolling or sliding truck, with a pivoting seat, riding on the track. The truck rolls or slides left and right to accommodate the lateral hip swing of the user and rotation of the seat around the pivot axis of the truck accommodates the rotation of the user's pelvis.

These alternative embodiments show that the heretofore described invention can be embodied in a wide variety of configurations as long as the objective traction force and lateral leg motion are imparted by thrust from the user's arms.

What is claimed is:

1. An apparatus for self-application of spinal traction and flexure by a user, said apparatus comprising
a moveable carriage, which includes
means for holding said user's ankles,
handles for applying force to said carriage, and
kinematic constraining members from said carriage to a floor pad that is kept in position by said user's mass.

2. A method for self-application of spinal traction and flexure by a user, said method comprising
delivering a spinal traction force from one's arms to one's ankles through a pair of handles to a carriage that grips one's ankles, while simultaneously delivering a displacement force to one handle, so as to flex the spine, then
alternating the application of said imbalanced force to one leg and then the other so as to flex the spine side-to-side with continuous traction

3. The apparatus of claim 1, wherein said carriage has wheels or rollers to allow said carriage to move easily on a floor or suitable working surface.

4. The apparatus of claim 1, wherein means are provided to adjust the vertical distance between said user's ankles in said carriage and the plane of said floor pad.

5. The apparatus of claim 1, wherein said means of holding said user's ankles consists of slots contoured to conform with the general shape of the prominences of human ankles, such that extensional force on said carriage in line with said user's legs and lateral translational force on said carriage are transmitted to said user's legs, pelvis, and spine.

6. The apparatus of claim 5, wherein said ankle-holding slots are lined with padding.

7. The apparatus of claim 6, wherein said padding is adjustable in thickness to accommodate different users who present a range of ankle widths.

8. The apparatus of claim 7, wherein said adjustable padding includes pneumatic bladders that change the dimension of the pad to form a compliant socket for said user's ankles.

9. The apparatus of claim 1, wherein said handles are connected to said carriage with multi-axis joints that provide freedom of rotation in both the horizontal and vertical planes.

10. The apparatus of claim 9, wherein said joints are affixed with a quick-acting attachment so as to allow said handles to be detached quickly from said carriage for transport or storage.

11. The apparatus of claim 1, wherein said handles are adjustable in length, so as to accommodate users of various heights and to support employment of said apparatus with a range of hand positions and arm orientations.

12. The apparatus of claim 1, wherein said kinematic constraining members are adjustable in length so as to accommodate users of various heights.

13. The apparatus of claim 1, wherein said floor pad includes a pivot point to restrain one end of said kinematic constraining members.

14. The apparatus of claim 1, wherein said floor pad includes a thickened section that elevates the user's torso above said floor pad so as to reduce the contact friction of said user's buttocks with said floor pad.

15. The apparatus of claim 14, wherein said thickened section is a separate pillow that may be moved to suit users of various heights.

16. The apparatus if claim 15, wherein said pillow is provided with means to affix said pillow to said floor pad at various positions to accommodate users of various heights.
